(19) United States
(12) Patent Application Publication
(10) Pub. No.: US 2025/0233757 A1
(43) Pub. Date: Jul. 17, 2025

(54) METHOD FOR ESTABLISHING A TOKEN FOR CERTIFYING AN INSTANTIATION OF A CLUSTER OF NODES

(71) Applicant: Orange, Issy-Les-Moulineaux (FR)

(72) Inventors: Gaël FROMENTOUX, Chatillon Cedex (FR); Frédéric FIEAU, Chatillon Cedex (FR); Emile STEPHAN, Chatillon Cedex (FR)

(21) Appl. No.: 18/703,182

(22) PCT Filed: Oct. 10, 2022
(86) PCT No.: PCT/EP2022/078150

§ 371 Date: Apr. 19, 2024

(30) Foreign Application Priority Data
Oct. 22, 2021 (FR) FR2111257

(51) Int. Cl. H04L 9/32

(52) U.S. Cl. CPC H04L 9/3263

(57) ABSTRACT

A solution for providing a certification token for an instantiation of a node cluster to an item of equipment requesting it in an “edge computing” environment. Existing authentication solutions are not well suited to the context of edge computing, as they cannot guarantee that the various parties involved in providing the requested service have instantiated all the nodes and/or servers in accordance with the technical and/or contractual constraints relating to the requested service. The present solution makes it possible to establish, and therefore be able to provide upon request, an instantiation certificate of a node cluster contributing to implementing a service. Such a certificate makes it possible to guarantee that the various items of equipment and parties involved in the execution and provision of a given service comply with the terms of a service provision contract.

### INCORPORATION BY REFERENCE TO ANY PRIORITY APPLICATIONS

This application is filed under 35 U.S.C. § 371 as the U.S. National Phase of Application No. PCT/FR2022/078150 entitled “METHOD FOR ESTABLISHING A TOKEN FOR CERTIFYING AN INSTANTIATION OF A CLUSTER OF NODES” and filed Oct. 10, 2022, which claims the benefit of French Patent Application No. 2111257, filed Oct. 22, 2021, each of which is incorporated by reference in its entirety.

### BACKGROUND

### Field

The field of the development is that of the establishment and provision of a certificate establishing a chain of compliance with certain prerequisites for the items of equipment involved in the provision of a service.

More precisely, the development relates to a solution for providing an instantiation certificate of a node cluster deployed in an edge computing environment.

### Prior Art and its Disadvantages

A new phase in the development of “cloud computing” has emerged in the last few years. This new development is known as “edge computing” and involves processing data at the edge of the network, as close as possible to the source of the data.

“Edge computing” minimises bandwidth requirements between equipment, such as sensors, and data processing centres by undertaking the analysis as close as possible to the data sources. This approach requires the mobilisation of resources that may not be permanently connected to a network, such as laptops, smartphones, tablets or sensors. “Edge computing” also plays a key role in content ingestion and delivery solutions. In this respect, many content delivery network (CDN) architectures are based on “edge computing” architectures.

A known implementation of such an “edge computing” architecture is an architecture referred to as Kubernetes.

FIG. 1 shows in a simplified manner the architecture of a node cluster 1 compliant with the Kubernetes architecture. The node cluster 1 comprises a first node 10 referred to as master node, or “Kubernetes master”, and N compute nodes, or “workers nodes”, 11i, i∈{1, . . . , N}, N being a natural integer.

The master node 10 comprises a controller 101, an API (Application Programming Interface) module 102 and an ETCD database 103 that consists of a dynamic configuration register for the compute nodes 11i.

A compute node 11i comprises M containers or “pods” 110j, j∈{1, . . . , M}, M being a natural integer. Each container 110j is equipped with resources for executing one or more tasks. When a task is executed, it contributes to implementing a network service or a function, such as a DHCP (Dynamic Host Configuration Protocol) function, for example.

With a view to reducing costs and improving the flexibility of network infrastructures, “edge computing” architectures are most often multi-site architectures in which the nodes constituting the node clusters can be non-co-located. For example, a master node 10 and two compute nodes 111, 112 of a node cluster 1 are located at a site A, while three other compute nodes 113, 114, 115 are located at a remote site B.

Existing authentication solutions, such as the https (HyperText Transfer Protocol Secure) protocol, that is based on the introduction of an encryption layer compliant with the SSL (Secure Socket Layer) or TLS (Transport Layer Security) protocol into the http (HyperText Transfer Protocol) protocol, are not well suited to the context of “edge computing”.

As an example, the https protocol allows a visitor's item of equipment, such as a personal computer, to verify the identity of a website that the visitor wants to access from their item of equipment.

Thus, the item of equipment uses an X509 public authentication certificate issued by a third-party authority, deemed to be reliable, to access a server providing a service. Such a certificate guarantees the confidentiality and integrity of the data transmitted by the visitor via their item of equipment to the server providing a service.

However, such a certificate cannot guarantee, for example a user of the service or the provider of the service in question, that the various parties involved in providing the requested service have instantiated all the nodes and/or servers in accordance with the technical and/or contractual constraints relating to the requested service.

There is therefore a need to propose a solution that does not have some or all of the above-mentioned disadvantages.

### SUMMARY

The development addresses this need by proposing a system comprising at least one node cluster comprising a master node and at least one compute node comprising at least one container intended to execute at least one task, at least one certification server and at least one item of equipment wishing to access a service implemented by said node cluster.

Such a system is particular in that:
said certification server is configured to transmit a first set of certification parameters to said master node
said master node is configured to establish a first instantiation certificate of said master node by means of the first set of certification parameters;
said certification server is configured to transmit at least one second set of certification parameters to at least one container of said compute node;
said master node is configured to obtain at least one second instantiation certificate for said container from said compute node, said second certificate being established by said compute node by means of the second set of certification parameters;
said master node is configured to transmit, to said certification server, a request for generating a certification token of an instantiation of the node cluster, said request comprising said first certificate and said second certificate;
said certification server is configured to generate said certification token of an instantiation of the node cluster by means of said first certificate and said at least one second certificate;
said certification server is configured to transmit said certification token of an instantiation of the node cluster to said master node;
said equipment is configured to transmit, to said master node, a request for establishing a session with said node cluster,
said master node is configured to transmit to the item of equipment a signalling message relating to the establishment of said session further comprising said certification token;
upon reception of said certification token, the item of equipment is configured to verify the authenticity of said certification token with said certification server.

The solution that is the subject of the development makes it possible to establish, and therefore to provide upon request, an instantiation certificate of a node cluster contributing to the implementation of a service. Such a certificate makes it possible to guarantee that the various items of equipment and parties involved in the execution and provision of a given service comply with the terms of a service provision contract and the requested technical specifications. To this end, the system includes a certification server deemed to be reliable, because it is endorsed by a third-party authority, whose function is to help establish certificates for nodes of a node cluster. When each node concerned has established its certificate by means of, among other things, certification parameters provided by the certification server, the latter generates a certification token grouping the set of certificates generated by the various nodes in the node cluster as well as other information relating to the service run by the node cluster.

In one example, the certification server can communicate directly with the containers without the intervention of the master node.

In another example, the certification server transmits the second set of certification parameters to the master node, which in turn transmits them to the container concerned.

Such a certification token may be requested by any item of equipment wishing to access the service run by the node cluster in question, in order to check the compliance of the instantiation with the terms of the service contract, for example.

Such a solution ensures for example that all the data provided by a user as part of the execution of a given service is processed by items of equipment located in a given territory.

More particularly, the master node of said node cluster implements a method for obtaining the certification token comprising the following steps:
establishing a first instantiation certificate of said master node by means of a first set of certification parameters requested from a certification server;
obtaining at least one second instantiation certificate for said container of said compute node, said second certificate being established by said compute node by means of at least one second set of certification parameters requested from the certification server;
transmitting, to said certification server, a request for generating said certification token of an instantiation of the node cluster, said request comprising said first certificate and said at least one second certificate;
receiving said certification token of an instantiation of the node cluster generated by the certification server.

The master node establishes its own certificate by means of certification parameters provided by the certification server and collects the different certificates established for the different containers concerned. Indeed, depending on the service for which the certification token is requested, only certain containers performing tasks relating to the execution of this service are called upon to provide an instantiation certificate.

In one example, the sets of certification parameters requested from the certification server comprise at least one item of timestamping information and one hash of an identifier of said certification server.

The item of timestamping information can limit the risk of fraud by defining a validity period of the set of certification parameters. The hash of an identifier of the certification server makes it possible to check the integrity of the set of certification parameters, so that the node using these certification parameters when establishing its certificate is certain of their origin and the values of these parameters, which contributes to forge a strong certificate.

In one example, the requested sets of certification parameters further include an item of location information.

An item of location information covers:
geolocation information such as GPS (Global Positioning System) coordinates obtained by means of a network identifier such as an IP address mask, a city identifier (e.g. Lannion), a region (e.g. Brittany) or a geographical area (e.g. Europe),
topographic location information such as a location in a communication network architecture, an identifier of a network domain to which the node cluster is attached,
an identifier for an organisation in charge of the network (e.g. a telecoms operator, a CDN infrastructure provider, a customer of an operator, etc.),

A combination of this different information.

In one example, the item of location information relates to the certification server which is co-located with the node cluster.

As the item of location information is provided by a reliable entity, i.e. the certification server, the user is guaranteed that all the data provided and processed as part of the execution of a given service are provided and processed by items of equipment located in a given territory.

In one example, the requested certification parameter sets are signed by means of a private cryptographic key of the certification server.

Thus, items of third-party equipment intercepting such sets of certification parameters are unable to use this data to forge their own certificates if they do not have the corresponding public cryptographic key.

As an example, a certificate is also established from data relating to said master node and belonging to the group comprising:
a network address of the master node;
a physical address of the master node;
at least one identifier of a model of the hardware constituting the master node;
at least one identifier of at least one software executed by the master node;
an identifier of an operator orchestrating said node cluster,
at least one identifier of at least one task performed by at least one container of at least one compute node of said cluster;
an identifier of at least one service provider on behalf of which a container performs a task;
a hash of at least one of the above data.

Thus, such a certificate includes information relating to the instantiation of the node, both structurally, i.e. geographical location, network address, information relating to the hardware used (reference to a memory model, processor model, etc.), and administratively, i.e. identity of the orchestrator, of a service provider, etc. as many information that allow to establish a chain of responsibility between all the entities involved in providing the requested service.

In one example, the certification token comprises at least one hash of the first certificate and the second certificate timestamped by the certification server.

This makes it possible to check the integrity of the certification token.

In order to guarantee its authenticity, the certification token can also be signed by means of the private cryptographic key of the certification server.

The development also takes the form of a method for establishing a certification token of an instantiation of a node cluster comprising a master node and at least one compute node comprising at least one container intended to execute at least one task.

Such a method is particular in that it comprises the following steps implemented by a certification server:
transmitting a first set of certification parameters to said master node;
transmitting at least one second set of certification parameters to at least one container of said compute node;
receiving, from said master node, a request for generating said certification token of an instantiation of the node cluster, said request comprising a first instantiation certificate of said master node established by means of the first set of certification parameters and at least one second instantiation certificate of said container established by means of the second set of certification parameters;
generating said certification token of an instantiation of the node cluster by means of said first certificate and said at least one second certificate;
transmitting said certification token of an instantiation of the node cluster generated to said master node.

In one example, the certification server can communicate directly with the containers without the intervention of the master node.

In another example, the certification server transmits the second set of certification parameters to the master node, which in turn transmits them to the container concerned.

The development also relates to a method for establishing a certificate of an instantiation of at least one container intended to execute at least one task, said container belonging to a compute node of a node cluster comprising a master node and a plurality of compute nodes.

Such a method is particular in that it comprises the following steps implemented by said container:
establishing a certificate instantiation of said container by means of a set of certification parameters requested from a certification server;
transmitting, to said master node, said certificate.

The development also relates to a method for verifying the authenticity of a certification token of an instantiation of a node cluster comprising a master node and at least one compute node comprising at least one container intended to execute at least one task.

Such a method is particular in that it comprises the following steps implemented by an item of equipment wishing to access a service implemented by said node cluster:
transmitting, to said master node, a request for establishing a session with said node cluster,
receiving a signalling message relating to the establishment of said session further comprising said certification token established by a certification server by means of a first instantiation certificate of said master node established by means of a first set of certification parameters requested from the certification server and at least one second instantiation certificate of said container established by means of a second set of certification parameters requested from the certification server;
a step of verifying the authenticity of said certification token with said certification server.

The development further relates to a master node of a node cluster also comprising at least one compute node comprising at least one container intended to execute at least one task, said master node comprising at least one processor configured to:
establish a first instantiation certificate of said master node by means of a first set of certification parameters requested from a certification server;
obtain at least one second instantiation certificate for said container of said compute node, said second certificate being established by said compute node by means of at least one second set of certification parameters requested from the certification server;
transmit, to said certification server, a request for generating said certification token of an instantiation of the node cluster, said request comprising said first certificate and said at least one second certificate;
receive said certification token of an instantiation of the node cluster generated by the certification server.

The development also relates to a certification server capable of establishing a certification token of an instantiation of a node cluster comprising a master node and at least one compute node comprising at least one container intended to execute at least one task, said certification server comprising at least one processor configured to:
transmit a first set of certification parameters to said master node;
transmit at least one second set of certification parameters to at least one container of said compute node;
receive, from said master node, a request for generating said certification token of an instantiation of the node cluster, said request comprising a first instantiation certificate of said master node established by means of the first set of certification parameters and at least one second instantiation certificate of said container established by means of the second set of certification parameters;
generate said certification token of an instantiation of the node cluster by means of said first certificate and said at least one second certificate;
transmit said certification token of an instantiation of the node cluster to said master node.

In one example, the certification server can communicate directly with the containers without the intervention of the master node.

In another example, the certification server transmits the second set of certification parameters to the master node, which in turn transmits them to the container concerned.

An object of the development is also a container belonging to a compute node of a node cluster comprising a master node and a plurality of compute nodes, said container comprising at least one processor configured to:
establish a certificate instantiation of said container by means of a set of certification parameters requested from a certification server;
transmit, to said master node, said certificate.

A final object of the development covers an item of equipment wishing to access a service implemented by a node cluster comprising a master node and at least one compute node comprising at least one container intended to execute at least one task, said item of equipment comprising at least one processor configured to:
transmit, to said master node, a request for establishing a session with said node cluster,
receive a signalling message relating to the establishment of said session further comprising said certification token established by a certification server by means of a first instantiation certificate of said master node established by means of a first set of certification parameters requested from the certification server and at least one second instantiation certificate of said container established by means of a second set of certification parameters requested from the certification server;
verify the authenticity of said certification token with said certification server.

Finally, the development relates to computer program products comprising program code instructions for implementing the methods as described previously, when they are executed by a processor.

The development also relates to a computer-readable storage medium on which are saved computer programs comprising program code instructions for implementing the steps of the methods according to the development as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer programs contained therein can be executed remotely. The programs according to the development can be downloaded in particular on a network, for example the Internet network.

Alternatively, the storage medium can be an integrated circuit in which the programs are embedded, the circuit being adapted to execute or to be used in the execution of the above-mentioned methods that are the subject of the development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows in a simplified manner the architecture of a node cluster compliant with the Kubernetes architecture,

FIG. 2: this figure shows a system in which the present solution can be implemented,

FIG. 3: this figure shows a diagram of the various steps implemented when executing the methods that are the subject of the development,

FIG. 4: this figure shows a master node of a node cluster capable of implementing the various methods that are the subject of the present development,

FIG. 5: this figure shows a configuration server capable of implementing the various methods that are the subject of the present development,

FIG. 6: this figure shows a container for a compute node of a node cluster capable of implementing the various methods that are the subject of the present development,

FIG. 7: this figure shows an item of equipment capable of implementing the various methods that are the subject of the present development.

### DETAILED DESCRIPTION OF CERTAIN ILLUSTRATIVE EMBODIMENTS

The general principle of the development is based on the establishment of a certification token of an instantiation of at least one node cluster deployed in an edge computing environment, which can guarantee that the various parties involved in providing the requested service have instantiated all the nodes and/or servers in accordance with the technical and/or contractual constraints relating to the requested service.

To this end, the development introduces a certification server deemed to be reliable, because it is endorsed by a third-party authority, whose function is to help establish certificates for nodes of the node cluster. When each node concerned has established its certificate by means of, among other things, certification parameters provided by the certification server, the latter generates a certification token grouping the set of certificates generated by the various nodes in the node cluster as well as other information relating to the service run by the node cluster.

Such a certification token may be requested by any item of equipment wishing to access the service run by the node cluster in question, in order to check the compliance of the instantiation with the terms of the service contract, for example.

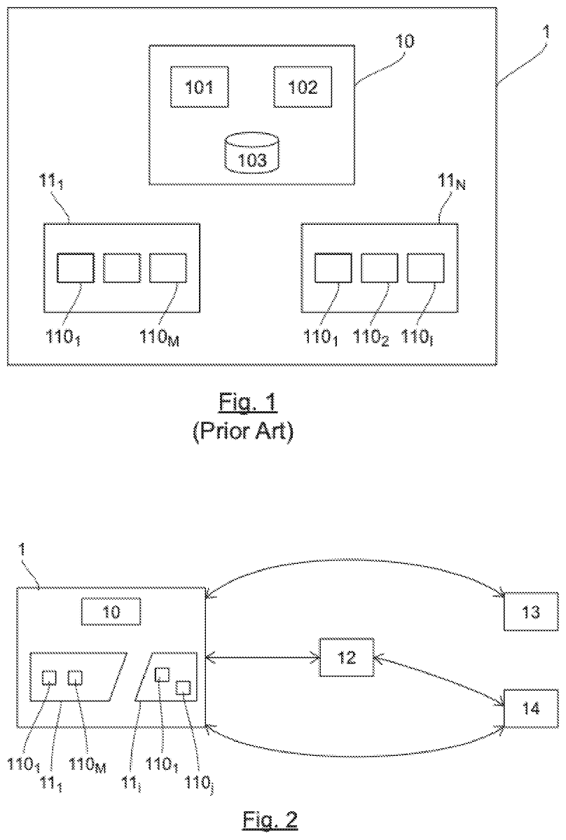

In relation to [FIG. 2], a system in which the present solution may be implemented is now presented.

Such a system comprises at least one node cluster 1 compliant with the Kubernetes architecture. The node cluster 1 comprises a first node 10 referred to as master node and N compute nodes 11i, i∈{1, . . . , N}, N being a natural integer.

A compute node 11i comprises M containers or “pods” 110j, j∈{1, . . . , M}, M being a natural integer. Each container 110j is equipped with resources for executing one or more tasks. When a task is executed, it contributes to implementing a network service or a function, such as a DHCP (Dynamic Host Configuration Protocol) function, for example.

The system also comprises a certification server 12. Such a certification server 12 is a reliable entity capable of issuing certificates. For example, a third-party authority recognised as reliable and honest verifies and then guarantees the reliability of such a certification server 12, which then becomes a trusted entity.

In one example, the certification server 12 is co-located with the node cluster 1. In another example, the certification server 12 is located at a site distant from the site housing the node cluster 1.

The system also includes other entities such as nodes 13 managed by a telecoms operator or a service provider.

Finally, the system includes at least one item of equipment (14) such as a mobile terminal, a server or a virtualised device.

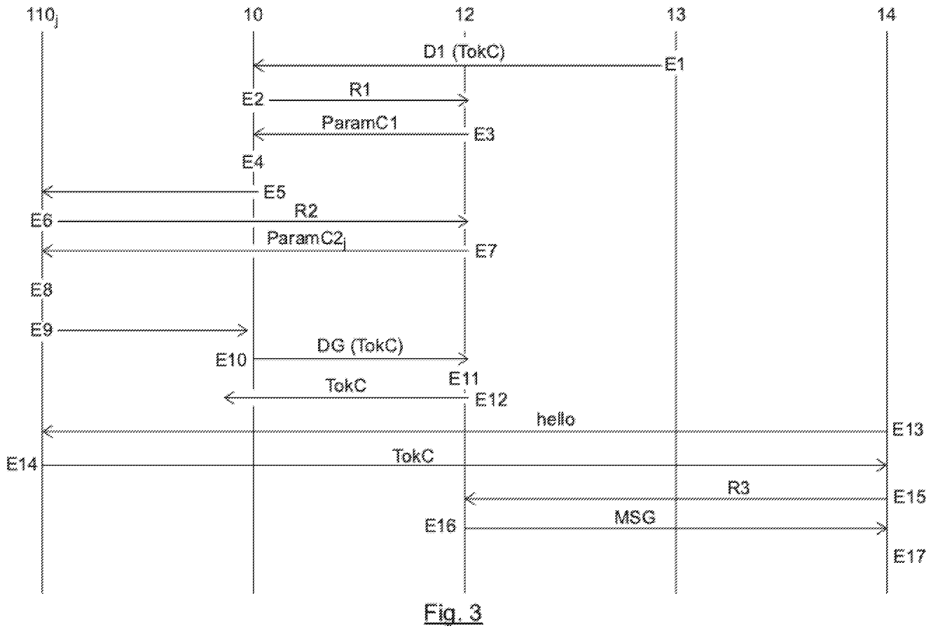

With reference to the system described in FIG. 2, the execution of the methods that are the subject of the development is now described. The various steps implemented when executing these methods within the system previously described are shown in the form of a diagram in [FIG. 3].

Thus, in a step E1, a node 13, belonging for example to a telecoms operator, transmits a request for the establishing D1 of a certification token TokC of at least one node cluster 1. Such a node cluster 1 may or may not be orchestrated by the telecoms operator. Such a request for establishing D1 is transmitted to the master node 10 of said node cluster 1. Such a request for establishing D1 includes an identifier of said node 13.

Upon reception of this request for establishing D1, the master node 10 transmits a request R1 to obtain a set of certification parameters ParamC1 from the certification server 12 during a step E2. Such a request R1 includes an identifier of the master node or a hash of the latter.

In response to the request R1, the certification server 12 generates, in a step E3, the set of certification parameters ParamC1. Such a set of certification parameters ParamC1 includes at least one item of timestamping information and a hash of an identifier of the certification server. Optionally, such a set of ParamC1 certification parameters can also include an item of location information.

An item of location information covers, for example:
geolocation information such as GPS (Global Positioning System) coordinates obtained by means of a network identifier such as an IP address mask, a city identifier (e.g. Lannion), a region (e.g. Brittany) or a geographical area (e.g. Europe),
topographic location information such as a location in a communication network architecture, an identifier of a network domain to which the node cluster is attached,
an identifier for an organisation in charge of the network (e.g. a telecoms operator, a CDN infrastructure provider, a customer of an operator, etc.),
the certification server 12 is co-located with the node cluster 1,
a combination of these different information.

In one example, the set of configuration parameters ParamC1 can be signed by means of a private cryptographic key of the certification server 12. In such an example, the master node 10 is in possession of a public cryptographic key of the certification server 12 corresponding to the private cryptographic key. Such a public cryptographic key of the certification server 12 can be provided to the master node 10 when a communication session is established with the certification server 12.

Upon reception of the set of configuration parameters ParamC1, the master node 10 establishes its instantiation certificate C10 during a step E4. Such a certificate C10 is established by means of the set of certification parameters ParamC1 and also of data relating to the master node and to the node cluster 1 it is responsible for. Such data belong to the group comprising:
a network address of the master node 10;
a physical address of the master node 10;
at least one identifier of a model of the hardware constituting the master node 10;
at least one version of at least one software executed by the master node 10;
an identifier of an operator orchestrating said node cluster 10,
at least one identifier of at least one task performed by at least one container 110j of at least one compute node 11 of said node cluster 1;
an identifier of at least one service provider on behalf of which a container 110j performs a task;
a hash of at least one of the pre-listed data.

The certificate C10 established by the master node 10 accounts for a chain of responsibility between all the entities involved in providing the requested service.

Once its certificate C10 has been established, the master node 10 requests from the various containers 110j concerned the establishment of their own certificate C110j during an E5 stage.

In one example, the master node 10 provides, via the compute node 11i which hosts them, information enabling the containers 110j to establish a direct connection with the certification server 12. When certain compute nodes 11i are located on different sites from the site hosting the master node 10 or the certification server 12, the master node 10 can provide the compute nodes 11i concerned with information enabling them to establish a connection with another certification server that is more appropriate, such as a certification server located on the same site or a certification server operating in a same domain, etc.

Each container concerned 110j then transmits a request R2 to the certification server 12 to obtain a set of certification parameters ParamC2j during a step E6. Such a request R2j includes an identifier of the master node or a hash of the latter.

In another example, the master node 10 transmits the request R2 to the certification server 12 to obtain a set of certification parameters ParamC2j on behalf of the container 110j.

In response to a request R2j, the certification server 12 generates, in a step E7, a set of certification parameters ParamC2j. Such a set of certification parameters ParamC2j comprises at least one item of timestamping information and a hash of the identifier of the certification server. Optionally, such a set of ParamC2j certification parameters can also include an item of location information. Depending on the example, the set of certification parameters ParamC2j is either transmitted directly to the container 110j or relayed by the master node 10.

In one example, the set of configuration parameters ParamC2j can be signed by means of a private cryptographic key of the certification server 12. In such an example, the container 110j is in possession of the public cryptographic key of the certification server 12 corresponding to the private cryptographic key. Such a public cryptographic key of the certification server 12 can be provided to the compute node 11i by the master node 10 when configuring the node cluster 1. It can also be provided directly to the container 110j by the master node during step E5.

Upon reception of the set of configuration parameters ParamC2j, the container 110j establishes its instantiation certificate C110j during a step E8.

Such a certificate C110j is established by means of the set of certification parameters ParamC2j but also of data relating to the computing node 11 hosting the container 110j and to the container 110j. Such data belong to the group comprising:
a network address of the compute node 11 and of the container 110j;
a physical address of the compute node 11 and of the container 110 j;
at least one identifier of a model of the hardware constituting the container 110 j and/or the compute node 11;
at least one version of at least one software executed by the container 110 j and/or the compute node 11;
an identifier of an operator orchestrating the compute node 11,
at least one identifier of at least one task performed by the container 110j;
an identifier of at least one service provider on behalf of which the container 110j performs a task;
a hash of at least one of the above data.

In a step E9, the master node 10 collects all the certificates C110j established by the containers 110j that have received a request R2. Once this collection has been performed, the master node 10 generates a generation request DG for the certification token TokC. Such a request DG includes the certificate C10 and all the certificates C110j collected. In one example, the generation request DG comprises a hash of certificates C10 and C110j.

Once generated, the generation request DG of said certification token TokC is transmitted to the certification server 12 on which the master node 10 depends in a step E10.

Upon reception of the request DG, the certification server 12 generates the certification token TokC in a step E11 from the certificates C10 and C110j received. For example, the certification server 12 can concatenate all the certificates C10 and C110j received and then timestamp the character string thus obtained. In another example, the certification server 12 can also sign the data constituting the certification token TokC by means of its private cryptographic key.

In a step E12, the certification server 12 transmits the certification token TokC thus generated to the master node 10.

The certification token TokC thus generated can, when needed and as requests are transmitted by certain parties involved in providing a service, be consulted and its authenticity can be verified. Indeed, as an example, a provider of a data storage service wants to be able to assure its users that their data is stored on servers located in a given geographical area. In such a case, before offering its service for sale, or even regularly during the provision of the service, the service provider can ensure that the servers are indeed located in the geographical area of interest by means of the certification token TokC. Of course, other technical and/or logistical characteristics or constraints can be checked in the same way using the certification token TokC. In the same way, it is possible to check that the most recent version of a software is running, that the appropriate type of RAM is used, or that a node cluster is orchestrated by the appropriate telecoms operator, etc.

Thus, an item of equipment 14 of a party involved in the provision of a service transmit, during a step E13, a hello request for establishing a communication session with a container 110j performing a task relating to the service provided. Such a hello request for establishing is either transmitted directly to the container 110j or is relayed to the container 110j by the master node 10.

Among the various data exchanged between the container 110j and the item of equipment 14, during a step E14, in order to establish a communication session is the certification token TokC. The container 110j also transmits an identifier of a certification server 12, such as a 1Pv4 or 1Pv6 network address, with which the authenticity of the certification token TokC can be verified.

Once the communication session has been established between the container 110j and the item of equipment 14, the latter transmits a request R3 to the certification server 12 during a step E15.

In response to this request R3, the certification server 12 transmits to the item of equipment 14 an MSG message containing its public cryptographic key and its own certificate, in a step E15.

Upon reception of the MSG message, the item of equipment 14 has the certificate of the certification server 12, which enables it to ensure the reliability of the latter and consequently the reliability of the certificates it has validated and of the certification tokens it has established. The item of equipment 14 can also decrypt the certification token TokC by means of the public cryptographic key it has received and thus access the certificates C10 and C110j and ensure that the service instantiation conditions that were requested are met in a step E17.

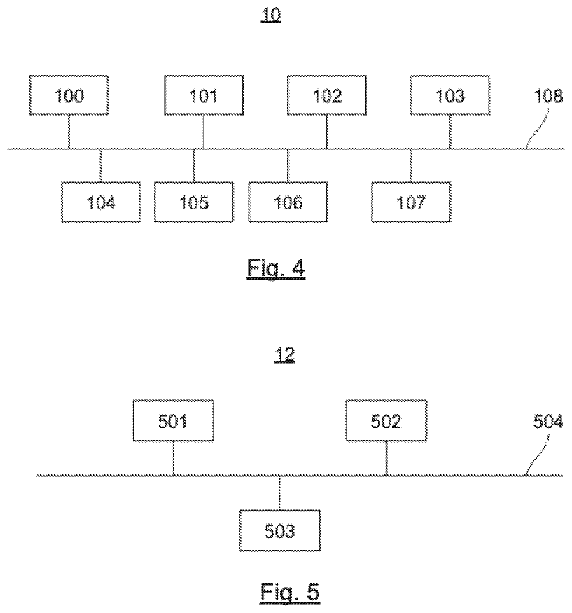

FIG. 4 shows a master node 10 of a node cluster 1 capable of implementing the various methods that are the subject of the present development.

A master node 10 may comprise at least on hardware processor 100, a storage unit 105, an interface 106, and at least one network interface 107 which are connected to each other via a bus 108 in addition to the API module 102, the controller 101, the database 103 and the synchronisation module(s) 104. Naturally, the components of the master node 10 can be connected by means of a connection other than a bus.

The processor 100 controls the operations of the master node 10. The storage unit 105 stores at least one program for implementing the various methods that are the subject of the development to be executed by the processor 100, and various data, such as parameters used for calculations performed by the processor 100, intermediate data for calculations performed by the processor 100, etc. The processor 100 may be formed by any known and appropriate hardware or software, or by a combination of hardware and software. For example, the processor 100 can be formed by a dedicated hardware such as a processing circuit, or by a programmable processing unit such as a Central Processing Unit which executes a program stored in a memory thereof.

The storage unit 105 may be formed by any appropriate means capable of storing the program or programs and data in a computer-readable manner. Examples of storage devices 105 include non-transitory computer-readable storage media such as semiconductor memory devices, and magnetic, optical or magneto-optical recording media loaded into a read/write device.

The interface 106 provides an interface between the master node 10 and at least one compute node 11i belonging to the same node cluster as the master node 10.

As for the network interface 107, it provides a connection between the master node 10 and the server 12 and/or the item of equipment 14.

FIG. 5 shows a certification server 12 capable of implementing the various methods that are the subject of the present development.

A certification server 12 may comprise at least one hardware processor 501, a storage unit 502, and at least one network interface 503 which are connected to each other via a bus 504. Naturally, the components of the certification server 12 can be connected by means of a connection other than a bus.

The processor 501 controls the operations of the certification server 12. The storage unit 502 stores at least one program for implementing the various methods that are the subject of the development to be executed by the processor 501, and various data, such as parameters used for calculations performed by the processor 501, intermediate data for calculations performed by the processor 501, etc. The processor 501 may be formed by any known and appropriate hardware or software, or by a combination of hardware and software. For example, the processor 100 can be formed by a dedicated hardware such as a processing circuit, or by a programmable processing unit such as a Central Processing Unit which executes a program stored in a memory thereof.

The storage unit 502 may be formed by any appropriate means capable of storing the program or programs and data in a computer-readable manner. Examples of storage devices 502 include non-transitory computer-readable storage media such as semiconductor memory devices, and magnetic, optical or magneto-optical recording media loaded into a read/write device.

As for the network interface 504, it provides a connection between the certification server 12 and at least one node of a node cluster 1 and/or an item of equipment 14.

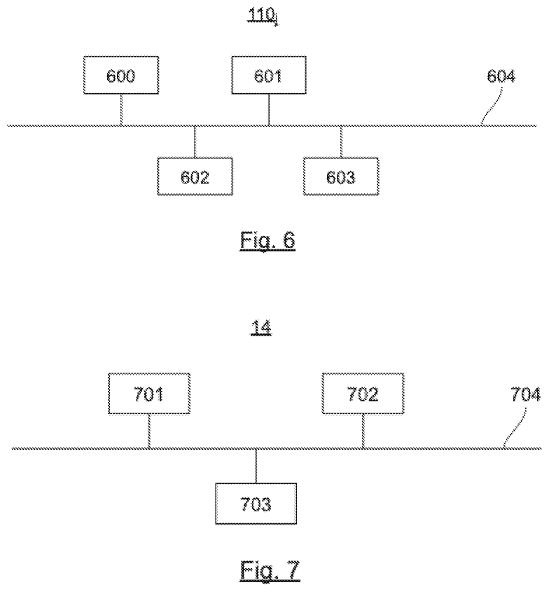

FIG. 6 shows a container 110j of a compute node 11i of a node cluster 1 capable of implementing the various methods that are the subject of the present development.

A container 110j may comprise at least one hardware processor 600, a storage unit 601, an interface 602, and at least one network interface 603 which are connected to each other via a bus 604. Naturally, the components of the container 110j can be connected by means of a connection other than a bus.

The processor 600 controls the operations of the container 110j. The storage unit 601 stores at least one program for implementing the various methods that are the subject of the development to be executed by the processor 600, and various data, such as parameters used for calculations performed by the processor 600, intermediate data for calculations performed by the processor 600, etc. The processor 600 may be formed by any known and appropriate hardware or software, or by a combination of hardware and software. For example, the processor 600 can be formed by a dedicated hardware such as a processing circuit, or by a programmable processing unit such as a Central Processing Unit which executes a program stored in a memory thereof.

The storage unit 601 may be formed by any appropriate means capable of storing the program or programs and data in a computer-readable manner. Examples of storage devices 601 include non-transitory computer-readable storage media such as semiconductor memory devices, and magnetic, optical or magneto-optical recording media loaded into a read/write device.

The interface 602 provides an interface between the container 110j and the compute node 11i to which it belongs.

As for the network interface 603, it provides a connection between the container 110j and the server 12 and/or the item of equipment 14.

FIG. 7 shows an item of equipment 14 capable of implementing the various methods that are the subject of the present development.

An item of equipment 14 may comprise at least one hardware processor 701, a storage unit 702 and an interface 703, which are connected to each other via a bus 704. Naturally, the components of the item of equipment 14 can be connected by means of a connection other than a bus.

The processor 701 controls the operations of the item of equipment 14. The storage unit 702 stores at least one program for implementing the various methods that are the subject of the development to be executed by the processor 701, and various data, such as parameters used for calculations performed by the processor 701, intermediate data for calculations performed by the processor 701, etc. The processor 701 may be formed by any known and appropriate hardware or software, or by a combination of hardware and software. For example, the processor 701 can be formed by a dedicated hardware such as a processing circuit, or by a programmable processing unit such as a Central Processing Unit which executes a program stored in a memory thereof.

The storage unit 702 may be formed by any appropriate means capable of storing the program or programs and data in a computer-readable manner. Examples of storage devices 702 include non-transitory computer-readable storage media such as semiconductor memory devices, and magnetic, optical or magneto-optical recording media loaded into a read/write device.

As for the network interface 703, it provides a connection between the item of equipment 14 and the certification server 12 and/or a container 110j of a compute node 11i of a node cluster 1.

1. A method of obtaining a certification token of an instantiation of a node cluster comprising a master node and at least one compute node comprising at least one container intended to perform at least one task, said method comprising the following implemented by said master node:
establishing a first instantiation certificate of said master node by means of a first set of certification parameters requested from a certification server;
obtaining at least one second instantiation certificate for said container of said compute node, said second certificate being established by said compute node by means of at least one second set of certification parameters requested from the certification server;
transmitting, to said certification server, a request for generating said certification token of an instantiation of the node cluster, said request comprising said first certificate and said at least one second certificate; and
receiving said certification token of an instantiation of the node cluster generated by the certification server.

2. The method of obtaining a certification token according to claim 1, wherein the sets of certification parameters requested from the certification server comprise at least one item of timestamping information and one hash of an identifier of said certification server.

3. The method of obtaining a certification token according to claim 2, wherein the requested sets of certification parameters also include an item of location information.

4. The method of obtaining a certification token according to claim 2, wherein the requested sets of certification parameters are signed by means of a private cryptographic key of the certification server.

5. The method of obtaining a certification token according to claim 1, wherein the first certificate is also established from data relating to said master node and belonging to a group comprising:
a network address of the master node;
a physical address of the master node;
at least one identifier of a model of the hardware constituting the master node;
at least one identifier of at least one software executed by the master node;
an identifier of an operator orchestrating said node cluster;
at least one identifier of at least one task performed by at least one container of at least one compute node of said cluster;
an identifier of at least one service provider on behalf of which a container performs a task; and
a hash of at least one of the above data.

6. The method of obtaining a certification token according to claim 1, wherein the certification token comprises at least one hash of the first certificate and the second certificate timestamped by the certification server.

7. The method of obtaining a certification token according to claim 6, wherein the certification token is signed by means of the private cryptographic key of the certification server.

8. A method of establishing a certification token for an instantiation of a node cluster comprising a master node and at least one compute node comprising at least one container intended to execute at least one task, said method comprising the following steps implemented by a certification server:
transmitting of a first set of certification parameters to said master node;
transmitting at least one second set of certification parameters to at least one container of said compute node;
receiving, from said master node, a request for generating said certification token of an instantiation of the node cluster, said request comprising a first instantiation certificate of said master node established by means of the first set of certification parameters and at least one second instantiation certificate of said container established by means of the second set of certification parameters;
generating said certification token of an instantiation of the node cluster by means of said first certificate and said at least one second certificate; and
transmitting said certification token of an instantiation of the node cluster to said master node.

9. A method of establishing a certificate of an instantiation of at least one container intended to execute at least one task, said container belonging to a compute node of a node cluster comprising a master node and a plurality of compute nodes, said method comprising the following implemented by said container:
establishing a certificate instantiation of said container by means of a set of certification parameters requested from a certification server; and
transmitting, to said master node, said certificate.

10. A method of verifying the authenticity of a certification token of an instantiation of a node cluster comprising a master node and at least one compute node comprising at least one container intended to execute at least one task, said method comprising the following steps implemented by an item of equipment wishing to access a service implemented by said node cluster:
transmitting, to said master node, a request for establishing a session with said node cluster;
receiving a signalling message relating to the establishment of said session further comprising said certification token established by a certification server by means of a first instantiation certificate of said master node established by means of a first set of certification parameters requested from the certification server and at least one second instantiation certificate of said container established by means of a second set of certification parameters requested from the certification server; and
verifying the authenticity of said certification token with said certification server.

11. Master A master node of a node cluster also comprising at least one compute node comprising at least one container intended to execute at least one task, said master node comprising at least one processor configured to:
establish a first instantiation certificate of said master node by means of a first set of certification parameters requested from a certification server;
obtain at least one second instantiation certificate for said container of said compute node, said second certificate being established by said compute node by means of at least one second set of certification parameters requested from the certification server;
transmit, to said certification server, a request for generating said certification token of an instantiation of the node cluster, said request comprising said first certificate and said at least one second certificate; and
receive said certification token of an instantiation of the node cluster generated by the certification server.

12. Certification A certification server capable of establishing a certification token of an instantiation of a node cluster comprising a master node and at least one compute node comprising at least one container intended to execute at least one task, said certification server comprising at least one processor configured to:
transmit a first set of certification parameters to said master node;
transmit at least one second set of certification parameters to at least one container of said compute node;
receive, from said master node, a request for generating said certification token of an instantiation of the node cluster, said request comprising a first instantiation certificate of said master node established by means of the first set of certification parameters and at least one second instantiation certificate of said container established by means of the second set of certification parameters;
generate said certification token of an instantiation of the node cluster by means of said first certificate and said at least one second certificate; and
transmit said certification token of an instantiation of the node cluster to said master node.

13. (canceled)

14. An item of equipment to access a service implemented by a node cluster comprising a master node and at least one compute node comprising at least one container intended to execute at least one task, said item of equipment comprising at least one processor configured to:
transmit, to said master node, a request for establishing a session with said node cluster;
receive a signalling message relating to the establishment of said session further comprising said certification token established by a certification server by means of a first instantiation certificate of said master node established by means of a first set of certification parameters requested from the certification server and at least one second instantiation certificate of said container established by means of a second set of certification parameters requested from the certification server; and
verify the authenticity of said certification token with said certification server.

15. (canceled)
